(19) United States
(12) Patent Application Publication
(10) Pub. No.: US 2009/0086579 A1
(43) Pub. Date: Apr. 2, 2009

(54) WEARABLE MEDICATION APPARATUS

(76) Inventor: Thomas Clark, Austin, TX (US)

Correspondence Address: ANDERSON LAW GROUP, PLLC, 9600 GREAT HILLS TRAIL, 150W, AUSTIN, TX, 78759, US

(21) Appl. No.: 12/191,297

(22) Filed: Aug. 13, 2008

Related U.S. Application Data
(60) Provisional application No. 60/995,606, filed on Sep. 28, 2007.

(51) Int. Cl. G04B 47/00; G04B 37/12

(52) U.S. Cl. 368/10; 368/278

(57) ABSTRACT

A wearable medication container includes a time piece incorporated into a first portion of the wearable apparatus; a second portion of the wearable apparatus, the second portion connected to the first portion via a hinge, the first portion and the second portion configured to include at least one insulating membrane; and a medication container incorporated into at least the second portion, the medication container configured to provide waterproof containment for medication.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. The present applicant entity has provided below a specific reference to the application(s) from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s). This application is a continuation in part of United States provisional patent application entitled WEARABLE MEDICATION CONTAINER, naming Thomas Clark as inventor, U.S. A No. 60/995,606 filed Aug. 13, 2007, by electronic filing.

### FIELD OF THE INVENTION

This invention pertains to pill containers incorporated into wearable mediation apparatus, and, more particularly, into a wearable apparatus designed for outdoor sports.

### BACKGROUND OF THE INVENTION

Pill boxes and pill containers are known for purposes of holding medication and are typically week long or month long containers kept in the home. Wearable pill containers include pill boxes incorporated into watches are known. For example, U.S. Pat. No. 7,196,972, entitled “Mediwatch”, to Pitocco et al., Mar. 27, 2007, a pill box incorporated into a watch is disclosed that is directed to a watch holding a pill box and providing for compartments and an alarm associated with each compartment.

Despite the many pill boxes available, it is documented that fully half of the 65 million people in the United States with hypertension fail to adhere to a regular drug regimen. Moreover, the American Pharmacists Association has estimated that poor adherence to medication regimens caused 11 to 20 percent of repeat visits to doctors, 125,000 deaths and 20 percent of hospitalizations. (The McKinsey Quarterly, Number 4, 2006). One reason for lack of adherence is the lack of pill boxes that are disposed within wearable apparatus for active wearers. Highly complex and breakable wearable pill boxes to date are simply not appropriate for those with active lifestyles. Given the increasing number of children and young adults with Type II diabetes and health problems requiring medications, the need for a wearable pill box apparatus becomes more and more apparent. Thus, a need exists for pill boxes incorporated into a watch or other wearable apparatus for active wearers, such as sports enthusiasts or other active persons who require medication.

The invention provides such an apparatus by disclosing a watch pill box capable of exposure to elements typical of a sport enthusiast. These and other advantages of the invention, as well as additional inventive features, will be apparent from the description of the invention provided herein.

### BRIEF SUMMARY OF THE INVENTION

The invention provides a time piece incorporated into a first portion of the wearable medication apparatus; a second portion of the wearable mediation apparatus, the second portion connected to the first portion via a hinge and a connector, the first portion and the second portion configured to include at least one insulating membrane; and a medication container incorporated into at least the second portion, the medication container including two or more compartments for holding medication, the medication container configured to provide waterproof containment for the medication.

Other aspects, objectives and advantages of the invention will become more apparent from the following detailed description when taken in conjunction with the accompanying drawings.

### BRIEF DESCRIPTION OF THE DRAWINGS

FIG. 1 is a perspective view of a wearable medication apparatus in accordance with an embodiment of the present application.

FIG. 2 is perspective view of an interior portion of a wearable medication apparatus in accordance with an embodiment of the present application.

FIG. 3 is a perspective view of a seal for use with a wearable medication apparatus in accordance with an embodiment of the present application.

FIG. 4 is perspective view of a sealing mechanism for use with a wearable medication apparatus in accordance with an embodiment of the present application.

FIG. 5 is isometric view of a wearable medication apparatus in accordance with an embodiment of the present application.

FIG. 6 is an exemplary computer system operable with the wearable medication apparatus in accordance with one or more embodiments of the present application.

### DETAILED DESCRIPTION OF THE INVENTION

The following examples further illustrate the invention but, of course, should not be construed as in any way limiting its scope.

The following examples further illustrate the invention but, of course, should not be construed as in any way limiting its scope.

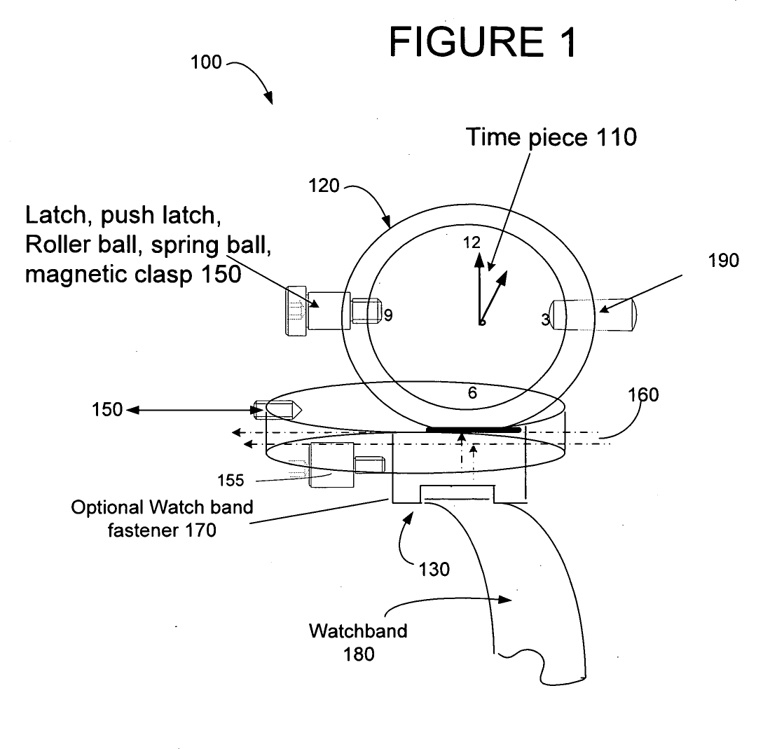

Referring now to FIG. 1, a wearable apparatus 100 for holding medication discloses a time piece 110 incorporated into a first portion of the wearable apparatus 120. The time piece can be a watch, pocket watch or other time piece for personal use. Also disclosed is a second portion 130 of the wearable apparatus 100. The second portion 130 is shown connected to the first portion 120 via a hinge 140 and a connector 150. Also shown disposed within the wearable apparatus 100 is at least one insulating membrane 160. In one embodiment, the connector is rugged enough to withstand outdoor activities and sports. For example, the connector can include a roller ball and spring latch in combination or alone with a magnetic connector, a latch, and/or a spring ball. In one embodiment, time piece 110 can be incorporated into a first portion of the wearable apparatus or the second portion as a watch such that the second portion includes a watchband fastener 170 and a watch band 180. Also disclosed in FIG. 1 is a watch setting and alarm setting component 190. Alarm setting can include two or more alarm settings for pill takers.

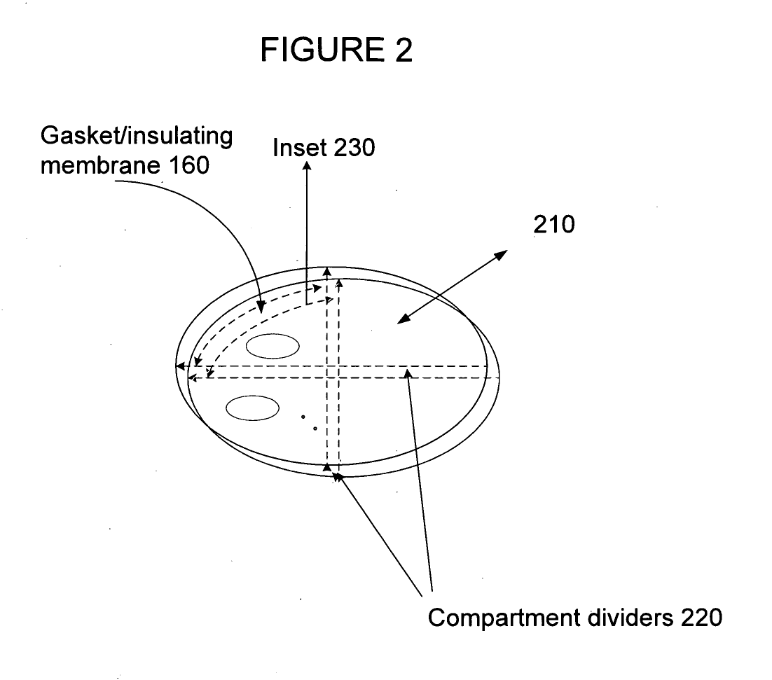

Referring to FIG. 2, the second portion 130 is shown in further detail. In one embodiment, the insulating membrane 160 can be configured to include a synthetic rubber made from polychloroprene as the insulating membrane. The insulating membrane can be configured to protect the medication from extreme temperatures to enable outdoor sports by a user. In such embodiments, the insulating membrane can be part of a gasket or can be separate from a sealing gasket 160. FIG. 2 also illustrates optional compartments 210, compartment dividers 220, and inset 230. The compartments can include one, two, three, four or more compartments as will be appreciated by one of skill in the art.

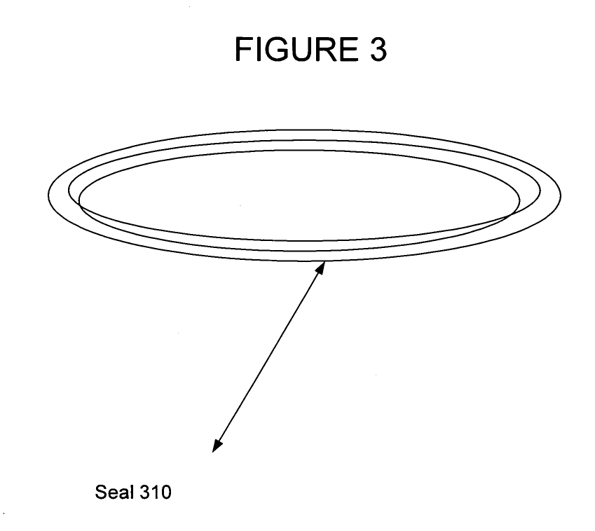

Referring now to FIG. 3, a seal 310 can be incorporated into the time piece backing is illustrated. The seal can be an insulating membrane as incorporated into the waterproof containment. For example, the insulating membrane incorporated into the waterproof containment can include a gasket such as an o-ring to provide a seal upon closing of the first portion onto the second portion as illustrated in FIG. 3. Seal 310 can include a silicone membrane or other appropriate sealing mechanism to maintain a waterproof seal. In one embodiment seal 310 is included in the first portion and the second portion as two insulating membranes that enclose the medication container. For example, the medication container can be an inset 230 shown in FIG. 2 with a seal 310 surrounding the inset 230.

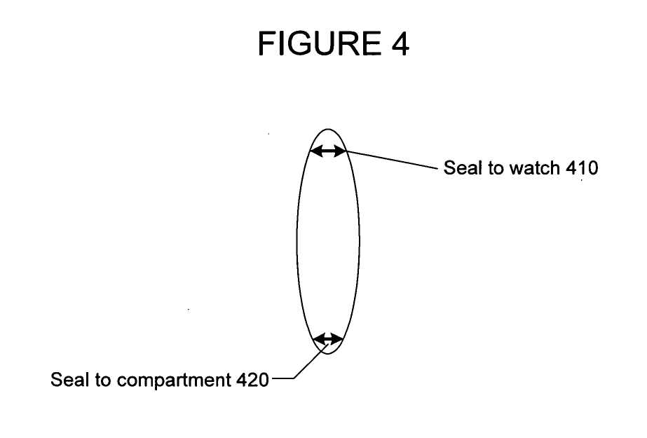

Referring now to FIG. 4, waterproof containment for the medication can include a silicone waterproof enclosure or other appropriate waterproof enclosure that includes a sealing mechanism incorporated into the first portion and the second portion such that closing the first portion onto the second portion seals the silicone waterproof enclosure. More particularly, a seal to the watch 410 can be adhered to the time piece 110 and a seal to the compartments 420 can be included. Such a seal can be configured in conjunction with a waterproof time piece 110 to enable underwater usage. Thus, SCUBA divers and other water sports will be able to have their medication with them.

In one embodiment, seals and gaskets 160, 310, 410, 420 can include insulation, such as neoprene or an appropriate thickness of silicone to provide temperature control. Accordingly, medications requiring a temperature range can be stored in the container. One or more seals and gaskets 160, 310, 410 and 420 can be configured to provide a shape that keeps medications such as pills from rattling within the medication container of the watch.

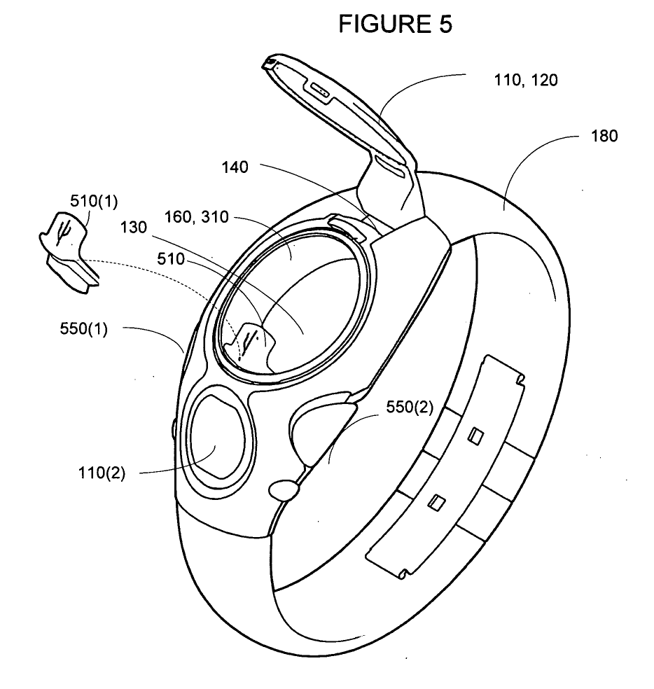

Referring now to FIG. 5, an isometric view of the wearable medication container is shown in an open configuration. As shown, a second portion 130 is shown connected to the first portion 120 via a hinge 140. Also shown disposed within the wearable apparatus 100 is at least one insulating membrane 160. As shown, time piece 110 can be incorporated into a first portion of the wearable apparatus. Alternatively, a time can be displayed as part of display 110(2) incorporated into a watchband. Display 110(2) and time piece 110 can include an alarm setting component 190. Alarm setting can include two or more alarm settings for pill takers. For example, the alarm settings can enable different dates and times for different medications and the like. In one embodiment, the alarm can be used to be associated with medications within the medication container and/or medications outside the medication container of the wearable apparatus. The alarm can be part of or incorporated with processor 155, which can be a microprocessor and memory component accessible through either user direct input or via a serial bus connection 510. In one embodiment processor 155 includes a global positioning transmitter configured to transmit a location of the wearable medication apparatus and transmit recorded data concerning the medication. For example, a radio frequency identification processor with a global positioning system (GPS) could be configured to transmit location and binary data stored within the wearable medication apparatus. Such a processor would benefit active medication users that wish to hike or explore areas away from a computer system.

In another embodiment, the alarm is configured to remind a user to take their medication according to their home time zone (preset by user) to insure that the user maintains their consistent medication schedule if they travel to different time zones. Thus, the medication timing schedule can be configured to operate independently from the clock settings of the time piece 110.

In one embodiment, display 110 and/or 110(2) can be programmed to scroll through various medications that a user takes at specific times. In one embodiment, the medication names can be configured to be displayed continuously and scroll on the watch display 110(2). The scroll of medicines required to be taken can continue until the user shuts the medication container door to insure that users take the correct medication and dosage.

The alarm can further be configured to record information related to the user such as recording instances of the watch medication container being opened and/or closed. A switch disposed within the hinge and/or sealing mechanism that detects a closed circuit can be coupled to the alarm of the wearable apparatus. In one embodiment, the closing of the circuit or other closing detection system is recorded along with a date and/or time within a memory component of the alarm. The recording can be displayed on display 110(2) to inform either the user or others whether the medication container was accessed, which can provide information concerning medication dispensing or lack thereof.

FIG. 5 further illustrates a computer connection 510, which can be a Universal Serial Bus (USB) connection or other appropriate connection. In one embodiment, USB connection 510 is removable as shown by the connection 510(1). Connection 510(1) can function as either a cover for a female connection within the medication container of the wearable apparatus or can include a memory such as a USB key that is then insertable into a computer USB female connection. The USB connection can be configured to be operable with the alarm disposed within the wearable apparatus. In one embodiment, the alarm is a processor records the opening and closing of the watch medication container door and stores data in memory adapted to provide graphs for a user to view on a computer system. The USB connection 510 can be configured to transfer the data to enable the graphing.

FIG. 5 further illustrates at least two actuators 550(1) and 550(2) on both sides of the wearable apparatus. In an embodiment, actuators 550(1) and 550(2) must both be pressed to open the medication container hinge so that a user does not accidentally open the medication container. The medication is therefore safely stored for users that use the wearable apparatus during sports or other activities and prevents accidental opening.

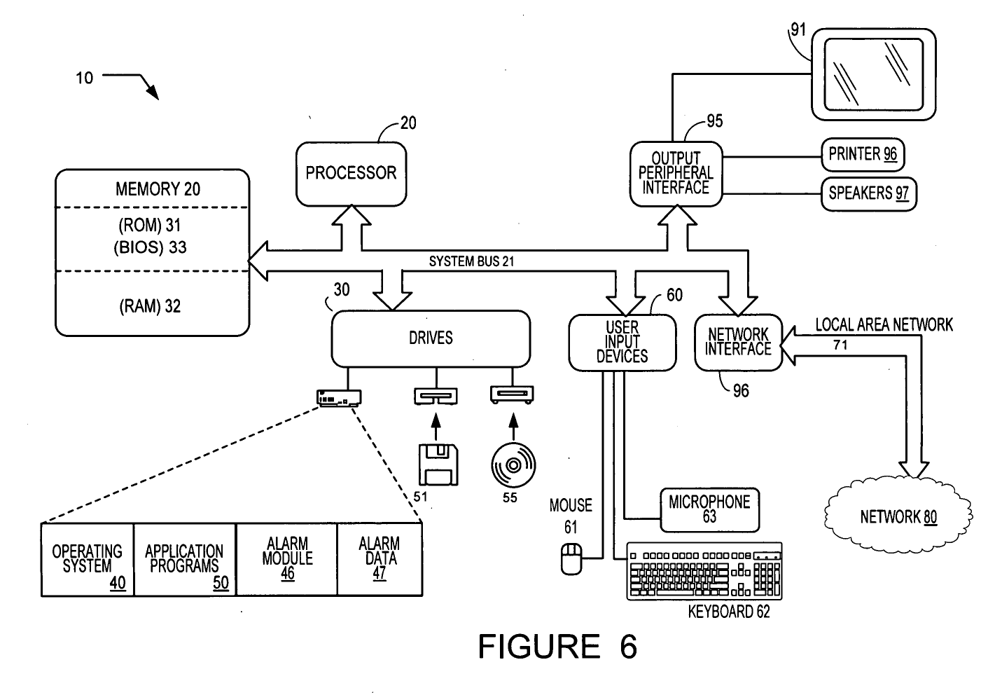

Referring now to FIG. 5 in combination with FIG. 6, the USB connection can be configured to be connected to a computer system to transfer data, program the alarm, transfer medication information and the like. FIG. 6 illustrates an exemplary computing system for implementing the embodiments and includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory, USB key memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. The computer 10 may also include other removable/non-removable, volatile/nonvolatile computer storage media. By way of example only, FIG. 1 illustrates a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50. An interface for purposes of this disclosure can mean a location on a device for inserting a drive such as hard disk drive 41 in a secured fashion, or a in a more unsecured fashion, such as interface 50. In either case, an interface includes a location for electronically attaching additional parts to the computer 10.

The drives and their associated computer storage media, discussed above and illustrated in FIG. 1, provide storage of computer readable instructions, data structures, program modules and other data for the computer 10. In FIG. 1, for example, hard disk drive 30 is illustrated as including alarm module 46 and alarm data 47. Alarm module 46 could be in non-volatile memory in some embodiments wherein such a program module that runs automatically in an environment. In other embodiments, alarm module 46 could part of an embedded system.

A user may enter commands and information into the computer 10 through input devices such as a microphone 63, a keyboard 62 and pointing device 61, commonly referred to as a mouse, trackball or touch pad. Other input devices may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB) connection, such as a connection to wearable apparatus 100. A monitor 91 or other type of display device is also connected to the system bus 21 via an interface, such as an output peripheral interface 95. The monitor 91 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 97 and printer 96, which may be connected through an output peripheral interface 95 or the like.

The computer 10 may operate in a networked environment 80 using logical connections to one or more remote computers, which could be cell phones, wearable apparatus 100 with a processor or other computers. The logical connections depicted in FIG. 1 include a local area network (LAN) 71 which can be a wide area network (WAN), but may also include other networks. Such networking environments are commonplace in offices, enterprise-wide computer networks, intranets and the Internet. For example, in the subject matter of the present application, the computer system 10 may comprise the source machine from which data is being migrated, and the remote computer may comprise the destination machine. Note however that source and destination machines need not be connected by a network or any other means, but instead, data may be migrated via any media capable of being written by the source platform and read by the destination platform or platforms.

Computer 10 can be connected to hardware such as wearable apparatus 100 configured in accordance with embodiments disclosed herein to accomplish functionalities associated with the alarm within the wearable apparatus 100. Computer 10 can be output device to collect data or can be included in the processing required for implementing disclosures herein. Thus, computer 10 can be agnostic to one or more disclosures and/or be incorporated as a necessary part of an embodiment as will be appreciated by one of skill in the art.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. A wearable apparatus for holding medication comprising:
a time piece incorporated into a first portion of the wearable apparatus;
a second portion of the wearable apparatus, the second portion connected to the first portion via a hinge, the first portion and the second portion configured to include at least one insulating membrane; and
a medication container incorporated into at least the second portion, the medication container configured to provide waterproof containment for the medication.

2. The wearable apparatus of claim 1, wherein said second portion of the wearable apparatus, the second portion connected to the first portion via a hinge, the first portion and the second portion configured to include at least one insulating membrane is configured to include a synthetic rubber made from polychloroprene as the insulating membrane, the insulating membrane configured to protect the medication from extreme temperatures.

3. The wearable apparatus of claim 1, wherein said second portion of the wearable apparatus, the second portion connected to the first portion via a hinge, the first portion and the second portion configured to include at least one insulating membrane is configured to include the insulating membrane as incorporated into the waterproof containment.

4. The wearable apparatus of claim 3, wherein said insulating membrane incorporated into the waterproof containment includes an o-ring to provide a seal upon closing of the first portion onto the second portion.

5. The wearable apparatus of claim 1, wherein said second portion of the wearable apparatus, the second portion connected to the first portion via a hinge, the first portion and the second portion configured to include at least one insulating membrane includes the insulating membrane is configured to include the insulating membrane as a sealing unit that encloses the medication container.

6. The wearable apparatus of claim 1, wherein the medication container incorporated into at least the second portion, the medication container configured to provide waterproof containment for the medication includes:
a silicone waterproof enclosure that includes a sealing mechanism incorporated into the first portion and the second portion such that closing the first portion onto the second portion seals the silicone waterproof enclosure.

7. The wearable apparatus of claim 1, wherein said time piece incorporated into a first portion of the wearable apparatus is configured to include an alarm integrated into the time piece.

8. The wearable apparatus of claim 7, wherein said time piece incorporated into a first portion of the wearable apparatus is configured to include an alarm integrated into the time piece further includes the alarm configured to enable one or more alarms for a plurality of dates and times associated with one or more medications within the medication container and/or medications outside the medication container of the wearable apparatus.

9. The wearable apparatus of claim 7, wherein said time piece incorporated into a first portion of the wearable apparatus is configured to include an alarm integrated into the time piece further includes the alarm configured to provide a medication timing schedule that operates independently from a clock setting of the time piece to enable a home time zone medication schedule.

10. The wearable apparatus of claim 1, further comprising:
at least two actuators located on the wearable apparatus, the at least two actuators configured to be pressed simultaneously to enable access to the medication container.

11. The wearable apparatus of claim 1, wherein said time piece incorporated into a first portion of the wearable apparatus is configured as a watch such that the second portion is coupled to a watch band.

12. The wearable apparatus of claim 1, wherein said hinge is configured to close via one or more of a latch, a snap, a magnetic connector, and a pressure connector.

13. The wearable apparatus of claim 1, further comprising:
a processor coupled to the second portion and/or the first portion of the wearable apparatus;
a memory coupled to the processor, the memory and the processor configured to provide an alarm and instantiate one or more programs associated with dispensing medications.

14. The wearable apparatus of claim 13, wherein the alarm is configured to record instances of the medication container being opened and/or closed.

15. The wearable apparatus of claim 14, wherein the alarm is configured to record instances of the medication container being opened and/or closed via a closing detection and/or circuit configured to record the date and/or time of access to the medication container within the memory.

16. The wearable apparatus of claim 13, wherein the processor and/or memory are configured to instantiate a program configured to scroll through a plurality of medications and display one or more medication names, the scrolling configured to continue until a user closes the medication container.

17. The wearable apparatus of claim 13, wherein the processor and/or memory are configured to communicate via a universal serial bus (USB) connection to a computer system and/or network.

18. The wearable apparatus of claim 13, wherein the processor and/or memory are configured to record data to enable one or graphs related to medication dosage and accesses to the medication container.

19. The wearable apparatus of claim 13, wherein the processor is coupled to a universal serial bus (USB) key within the medication container, the USB key configured to record data.

20. The wearable apparatus of claim 19, wherein the processor is configured to include a global positioning transmitter to enable locating of the wearable medication apparatus and transmit recorded data concerning the medication.
